(19) United States
(12) Patent Application Publication
(10) Pub. No.: US 2025/0383431 A1
(43) Pub. Date: Dec. 18, 2025

(54) SYSTEM HAVING PHOTODETECTOR AND PROCESSOR FOR DETERMINING OCURRENCE OF CONTAMINATION ON WINDOW SURFACE AND METHOD THEREFOR

(71) Applicant: Rockwell Collins, Inc., Cedar Rapids, IA (US)

(72) Inventors: Curt A. Dykstra, Chaska, MN (US); Britta G. Nordberg, Shoreview, MN (US)

(21) Appl. No.: 18/747,193

(22) Filed: Jun. 18, 2024

(51) Int. Cl. G01S 7/497; G01S 7/487

(52) U.S. Cl. CPC G01S 7/497; G01S 7/4876; G01S 2007/4975

(57) ABSTRACT

A system includes: a laser emitter configured to emit a laser through a window, wherein, in the presence of contaminant on the second surface, at least part of the laser is backscattered from the contaminant as backscatter rays; a reflective surface configured to reflect the backscatter rays as reflected rays; a filter configured to filter out wavelengths of interference light; a lens configured to focus the filtered rays as focused rays; a photodetector configured to convert the focused rays into an electric signal; an amplifier configured to amplify the electric signal; an analog-to-digital converter (ADC) configured to output the converted electric signal as at least one digital electric signal; and a processor configured to receive the digital electric signal.

### BACKGROUND

Currently, optical sensor systems, such as Lidar sensor systems, that are installed in aircraft emit a laser through an optical sensor window and measure return signals (e.g., reflected off an environment external to the aircraft. Such optical sensor systems used in aircraft are prone to contamination of an exterior surface of the window where the laser is transmitted through. For example, window contamination can lead to attenuation of the transmitted laser beam, thereby decreasing signal power and degrading a return signal, to be detected by such optical sensor system. Such contamination can lead to unreliable data collection methods. Existing solutions to detect such contamination use complex optic components and/or arrangements, use an additional laser emitter other than the optical system's laser emitter, use larger components than available space will permit, use devices installed external to the optical sensor system, require significant computing capabilities and/or power, and/or are expensive.

### SUMMARY

In one aspect, embodiments of the inventive concepts disclosed herein are directed to a system. The system may include a laser emitter configured to emit a laser along an initial laser path toward and at least partially through a window, the window having a first surface and a second surface, wherein the window is exposed to possible contaminants at least on the second surface, wherein, in the presence of at least one contaminant on the second surface, at least part of the laser is backscattered from a portion of the at least one contaminant toward and at least partially through the first surface as backscatter rays; at least one reflective surface positioned out of the initial laser path, the at least one reflective surface configured to reflect at least a portion of the backscatter rays as reflected rays; at least one filter configured to filter out wavelengths of interference light outside of a wavelength band of the reflected rays and/or of the laser and to output filtered rays; at least one lens configured to receive the filtered rays and to focus the filtered rays as focused rays; at least one photodetector configured to receive at least some of the focused rays and to convert at least a portion of the at least some the focused rays into at least one electric signal; at least one amplifier configured to amplify the at least one electric signal; at least one analog-to-digital converter (ADC) configured to convert the at least one amplified electric signal from analog to digital and to output the at least one converted electric signal as at least one digital electric signal; and at least one processor configured to receive the digital electric signal.

In a further aspect, embodiments of the inventive concepts disclosed herein are directed to a method. The method may include: by a laser emitter: emitting a laser along an initial laser path toward and at least partially through a window, the window having a first surface and a second surface, wherein the window is exposed to possible contaminants at least on the second surface, wherein, in the presence of at least one contaminant on the second surface, at least part of the laser is backscattered from a portion of the at least one contaminant toward and at least partially through the first surface as backscatter rays; by at least one reflective surface positioned out of the initial laser path: reflecting at least a portion of the backscatter rays as reflected rays; by at least one filter: (a) filtering out wavelengths of interference light outside of a wavelength band of the reflected rays and/or of the laser and (b) outputting filtered rays; by at least one lens: (a) receiving the filtered rays and (b) focusing the filtered rays as focused rays; by at least one photodetector: (a) receiving at least some of the focused rays and (b) converting at least a portion of the at least some of the focused rays into at least one electric signal; by at least one amplifier: amplify the at least one electric signal; by at least one analog-to-digital converter (ADC): (a) converting the at least one amplified electric signal from analog to digital and (b) outputting the at least one converted electric signal as at least one digital electric signal; and by at least one processor: receiving the digital electric signal.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 shows an exemplary embodiment of a system according to the inventive concepts disclosed herein.

FIG. 2 shows an exemplary graph, with respect to an exemplary laser signal (e.g. a pulsed laser signal) emitted by the laser emitter, of laser power versus time for the exemplary laser signal according to the inventive concepts disclosed herein.

FIG. 3 shows an exemplary graph, with respect to an exemplary electric signal (associated with backscatter rays from the laser signal illustrated by and described with respect to FIG. 2) output by the ADC, of electric signal power versus time for the exemplary electric signal according to the inventive concepts disclosed herein.

FIG. 4 shows an exemplary graph, with respect to an exemplary laser signal emitted by the laser emitter, of laser power versus time for the exemplary laser signal according to the inventive concepts disclosed herein.

FIG. 5 shows an exemplary graph, with respect to an exemplary electric signal (associated with backscatter rays from the laser signal illustrated by and described with respect to FIG. 4 (e.g., a digital electric signal corresponding) output by the ADC, of electric signal power versus time for the exemplary electric signal according to the inventive concepts disclosed herein.

FIG. 6 is a diagram of an exemplary embodiment of a method according to the inventive concepts disclosed herein.

FIGS. 7, 8, and 9 show a table and graphs associated with a portion of test result data associated with one exemplary and tested embodiment according to the inventive concepts disclosed herein.

FIG. 10 is a diagram of an exemplary embodiment of a method according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein may be directed to a system (e.g., an optical sensor system, such as a Lidar sensor system), a vehicular system (e.g., an aircraft system), and/or a system including a laser emitter (e.g., of an optical sensor system or another laser emitter), a window, at least one photodetector, and/or at least one processor) and a method configured to determine an occurrence of contamination on at least one surface of a window.

Some embodiments may detect contamination on the window of an optical sensor and/or on a window (e.g., of a vehicle, of an optical device, or of a structure) using reflected backscatter from a laser source (e.g., a primary or secondary laser source).

Some embodiments may include an optical window contamination detection device for an optical sensor system that has a laser beam transmitted (e.g., orthogonally transmitted) through a window and into the atmosphere. For example, window contamination can lead to attenuation of the transmitted laser beam, thereby decreasing signal power and degrading a return signal, to be detected by a photodetector of the optical sensor system. Some embodiments can detect contamination on windows, where such contamination could lead to degradation; and some embodiments can issue instructions and/or alerts operators of an existence of potentially unreliable and/or noisy data and/or faulty data collection environments.

In some embodiments, a window contamination sensor system may include a reflective surface, a band-pass filter (BPF) centered on the transmit laser beam's wavelength, a focusing lens, a photodiode, and/or a processor. When the beam interacts with a contaminant at the window exterior surface, a portion of the light is backscattered and redirected to a detector by the reflective and focusing lens. The output of the photodiode may be analyzed by the processor. The quantity of scattered light may be proportional to the transmission loss through the window. This relationship may allow contamination thresholds to be determined, which may depend at least on the strength of the backscattered signal and/or the criticality of the laser transmission power loss.

In some embodiments, the window contamination sensor system's devices may be contained within the optical sensor system (e.g., Lidar system), and the window contamination sensor system may use the primary laser source of the optical sensor system to signal a fault condition. In addition, some embodiments are novel at least because window contamination detection may be related to (e.g., proportional to) the primary laser's transmission power such that the window contamination sensor system may be configured to sense (e.g., only sense) contaminants that cause decreased transmission caused by contaminant backscattering of the laser.

Some embodiments may be incorporated into existing optical systems. Other embodiments may be newly designed optical systems or may be a part of newly designed optical systems.

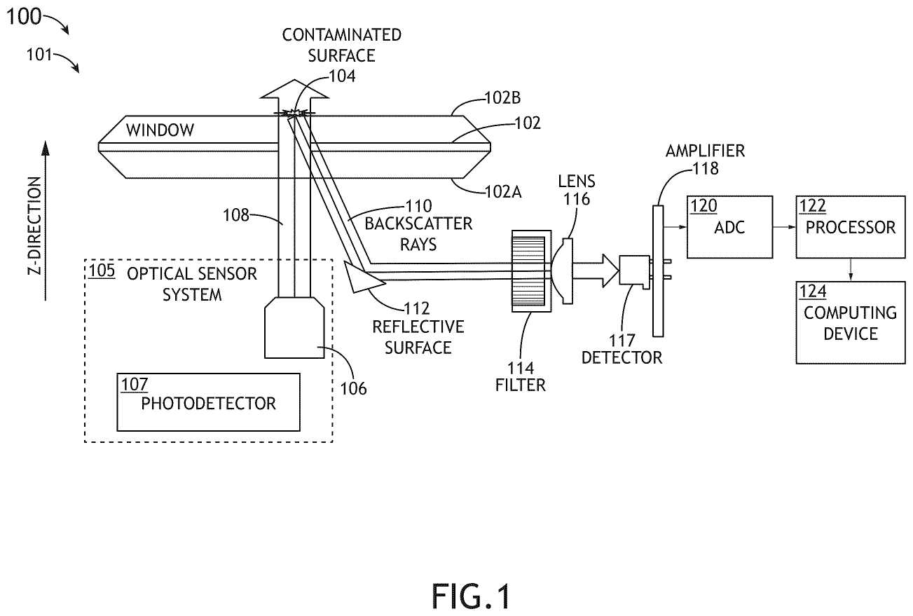

Referring now to FIG. 1, an exemplary embodiment of a system 100 (e.g., at least one optical sensor system 105, an environmental system, a structural system, an imaging system, a communication system, or a vehicular system (e.g., an aircraft system, watercraft system, submersible vessel system, spacecraft system, or automobile system)) according to the inventive concepts disclosed herein is depicted. In some embodiments, the system 100 may include a vehicle (e.g., an aircraft 101, watercraft, submersible vessel, spacecraft, or automobile).

Often, aircraft applications involve mechanical constraints on dimensions of the installation of the optical sensor system 105. For example, there can be a maximum allowed distance (e.g., which may correspond to a full distance of a mechanical package of the optical sensor system 105) as measured orthogonally from the window to the laser emitter 106 (e.g., in the z-direction). In some embodiments, a position of the at least one mirror 112 (e.g., which can redirect the backscatter rays in a direction orthogonal to the z-direction) in the z-direction allows installation of the at least one mirror 112, the at least one filter 114, the at least one lens 116, the at least one photodetector 117, the at least one amplifier 118, the at least one ADC 120, and the at least one processor 122 to the optical sensor system 105 adds no z-dimensional size to the optical sensor system 105.

In some embodiments, the system 100 may include at least one window 102 (e.g., each of which may be an apparatus defined by at least two surfaces (e.g., at least two planar or curved surfaces, where the at least two surfaces may be parallel and/or conformal); e.g., comprised of at least one material that is at least transparent (e.g., at least one transparent and/or translucent material, such as transparent or translucent glass or plastic), at least one contaminant 104, at least one a laser emitter 106 (e.g., at least one primary laser emitter and/or at least one other laser emitter), at least one reflective surface 112 (e.g., of at least one mirror and/or of at least one turning prism), at least one filter 114 (e.g., at least one band-pass filter (BPF), at least one low-pass filter (LPF), and/or at least one high-pass filter (HPF)), at least one lens 116, at least one photodetector 117 (e.g., any device that can drive a current and/or voltage in response to light; e.g., at least one photodiode, at least one photovoltaic cell, and/or at least one image sensor), at least one amplifier 118 (e.g., at least one passive and/or at least one powered amplifier), at least one analog-to-digital converter (ADC) 120, at least one processor 122, at least one computing device 124, some or all of which may be partially and/or fully coupled (e.g., optically, communicatively, and/or electrically coupled) at any given time.

In some embodiments, the system 100 may be or may include at least one optical sensor system 105 (e.g., a Lidar system; e.g., which may be installed on and/or in a vehicle). For example, the optical sensor system 105 may include at least one window 102, at least one photodetector 107 (e.g., which may be implemented similar to and/or function similar to the at least one photodetector 117) the at least one laser emitter 106, the at least one reflective surface 112, the at least one filter 114, the at least one lens 116, the at least one photodetector 117, the at least one amplifier 118, the at least one ADC 120, and/or the at least one processor 122, some or all of which may be partially and/or fully coupled (e.g., optically, mechanically, communicatively, and/or electrically coupled) at any given time.

In some embodiments, at least one laser emitter 106 may be configured to (e.g., collectively configured to and/or configured in series and/or parallel to, if more than one) emit a laser 108 along an initial laser path toward and at least partially through a window 102. The window 102 may have a first surface 102A and a second surface 102B. The window 102 may be exposed to possible contaminants 104 at least on the second surface 102B. In the presence of at least one contaminant 104 on the second surface 102B, at least part of the laser 108 may be backscattered from a portion of the at least one contaminant 104 toward and at least partially through the first surface 102A as backscatter rays 110. In some embodiments, the area of interest may be the laser 108 exit point on the second surface 102B (e.g., an exterior window surface). For example, the laser 108 exit point on the second surface 102B may be an important area to keep clean and/or free of contaminants, which can attenuate signal strength and/or cause backscatter rays 110.

In some embodiments, at least one reflective surface 112 may be positioned out of the initial laser path. The at least one reflective surface 112 may be configured to (e.g., collectively configured to and/or configured in series and/or in parallel to, if more than one) reflect at least a portion of the backscatter rays 110 as reflected rays.

In some embodiments, at least one filter 114 may be configured to (e.g., collectively configured to and/or configured in series and/or parallel to, if more than one) filter out wavelengths of interference light (e.g., solar light and/or cosmic rays) outside of a wavelength band of the reflected rays and/or of the laser 108 and to output filtered rays. For example, a pass wavelength band of the at least one BPF may be centered on the laser's 108 wavelength band.

In some embodiments, at least one lens 116 may be configured to (e.g., collectively configured to and/or configured in series and/or parallel to, if more than one) receive the filtered rays and to focus the filtered rays as focused rays.

In some embodiments, at least one photodetector 117 may be configured to (e.g., collectively configured to and/or configured in series and/or parallel to, if more than one) receive at least some (e.g., most or substantially all of) of the focused rays and to convert at least a portion of the at least some of the focused rays into at least one electric signal. In some embodiments, the photodetector 117 is aligned with the lens 116.

In some embodiments, at least one amplifier 118 may be configured to (e.g., collectively configured to and/or configured in series and/or parallel to, if more than one) amplify (e.g., by a known amount) the at least one electric signal.

In some embodiments, at least one analog-to-digital converter (ADC) 120 may be configured to (e.g., collectively configured to and/or configured in series and/or parallel to, if more than one) convert the at least one amplified electric signal from analog to digital and to output the at least one converted electric signal as at least one digital electric signal.

In some embodiments, at least one processor 122 may be configured to receive the digital electric signal. For example, the at least one processor 122 may be coupled to at least one memory and/or at least one storage, some or all of which may be communicatively coupled at any given time. For example, the at least one processor 122 may include at least one central processing unit (CPU), at least one graphics processing unit (GPU), at least one controller, at least one field-programmable gate array (FPGA), at least one application specific integrated circuit (ASIC), at least one digital signal processor, at least one virtual machine (VM) running on at least one processor, and/or the like configured to perform (e.g., collectively perform) any of the operations disclosed throughout. For example, the at least one processor 122 may include at least one controller, at least one CPU, at least one FPGA, and/or at least one ASIC configured to perform (e.g., collectively perform, if more than one) any of the operations disclosed throughout. The processor 122 may be configured to run various software applications or computer code stored (e.g., maintained) in a non-transitory computer-readable medium (e.g., memory and/or storage) and configured to execute various instructions or operations. The processor 122 may be configured to perform any or all of the operations disclosed throughout.

In some embodiments, the at least one computing device 124 may include the at least one processor 122; in other embodiments, each of the computing device 124 may include at least one other processor (not shown; e.g., which may be implemented similar to and/or function similar to the at least one processor 122). Each of the at least one computing device 124 may be implemented as any device having at least one processor and/or may be any suitable computing device, such as at least one optical sensor system having at least one processor, at least one workstation computer, at least one server, at least one personal computer (PC), at least one imaging device (e.g., a camera having at least one processor). For example, the computing device 124 may include at least one processor (e.g., similar to and with functionality similar to the processor 122), at least one memory, and/or at least one storage, some or all of which may be communicatively coupled at any given time. For example, the at least one processor may include at least one central processing unit (CPU), at least one graphics processing unit (GPU), at least one controller, at least one field-programmable gate array (FPGA), at least one application specific integrated circuit (ASIC), at least one digital signal processor, at least one virtual machine (VM) running on at least one processor, and/or the like configured to perform (e.g., collectively perform) any of the operations disclosed throughout. For example, the at least one processor may include a CPU and a GPU configured to perform (e.g., collectively perform) any of the operations disclosed throughout. The processor may be configured to run various software applications or computer code stored (e.g., maintained) in a non-transitory computer-readable medium (e.g., memory and/or storage) and configured to execute various instructions or operations.

In some embodiments, the at least one processor 122 and/or the computing device 124 may be configured to (e.g., collectively configured to and/or configured in series and/or parallel to, if more than one): receive the at least one digital electric signal.

In some embodiments, the at least one processor 122 and/or the computing device 124 may be further configured to (e.g., collectively configured to and/or configured in series and/or parallel to, if more than one): output at least one instruction (e.g., to cause at least one alert to be issued, to cause at least one maintenance event (e.g., clean the window 102 and/or replace the window 102) to be scheduled and/or performed, and/or to cause a deactivation of the laser emitter 106 and/or of the optical sensor system 105) and/or cause at transmission of at least one output signal based at least on at least one comparison of one or more of the at least one digital electric signal to a predetermined threshold level. For example, each of the at least one digital electric signal may be associated with (e.g., indicative of and/or representative of) a power of an analog signal (e.g., one of the at least one electric signal and/or one of the at least one amplified electric signal).

In some embodiments, the at least one processor 122 and/or the computing device 124 may be configured to (e.g., collectively configured to and/or configured in series and/or parallel to, if more than one): output at least one instruction, at least one message, at least one alert and/or at least one output signal based at least on a determination that at least one sampled power level and/or at least one sampled persistence level associated with (e.g., indicated by and/or represented by) the at least one digital electric signal exceeds at least one predetermined threshold power level and/or at least one predetermined persistence threshold.

In some embodiments, the at least one processor 122 and/or the computing device 124 may be configured to (e.g., collectively configured to and/or configured in series and/or parallel to, if more than one): obtain laser power information associated with at least one power of the laser 108; and determine and/or obtain digital electric signal information associated with at least one of (a) at least one power or (b) at least one of at least one current or at least one voltage of at least one analog signal of the at least one electric signal and/or of the at least one amplified electric signal. In some embodiments, the at least one processor 122 and/or the computing device 124 may be further configured to (e.g., collectively configured to and/or configured in series and/or parallel to, if more than one): compare the laser power information and the digital electric signal information; and based at least on the comparison of the laser power information and the digital electric signal power information, determine that at least one of the first or second surface 102A, 102B is contaminated and/or is likely contaminated. In some embodiments, the at least one processor 122 and/or the computing device 124 may be further configured to (e.g., collectively configured to and/or configured in series and/or parallel to, if more than one): determine at least one type of matter (e.g., any matter or combination of matter that blocks or partially blocks the laser emission, such as at least one of liquid water, ice, deicer, dirt, dust, powder, ash, a coating (e.g., paint), or grease) that is contaminating the first and/or second surface 102A, 102B. In some embodiments, the at least one processor 122 and/or the computing device 124 may be configured to (e.g., collectively configured to and/or configured in series and/or parallel to, if more than one): cause an alert to be issued, wherein the alert is indicative that the at least one of the first or second surface 102A, 102B is contaminated and/or is likely contaminated. In some embodiments, the at least one processor 122 and/or the computing device 124 may be configured to (e.g., collectively configured to and/or configured in series and/or parallel to, if more than one): cause a maintenance event to be scheduled to clean the at least one of the first or second surface 102A, 102B. In some embodiments, the system 100 is an optical sensor system 105, and/or the at least one processor 122 and/or the computing device 124 may be configured to (e.g., collectively configured to and/or configured in series and/or parallel to, if more than one): cause at least one of (a) a deactivation of the laser emitter 106 and/or the optical sensor system 105 or (b) an alert to be issued, wherein the alert is indicative that information obtained by the optical sensor system 105 is at least one of unreliable (e.g., faulty).

In some embodiments, the laser emitter 106, the at least one reflective surface 112, the at least one filter 114, the at least one lens 116, the at least one photodetector 117, the at least one amplifier 118, the at least one ADC 120, the at least one processor 122, and/or the at least one computing device 124 may be installed in and/or on a vehicle (e.g., an aircraft 101). In some embodiments, the window 102 may be a vehicular window or a window of the optical sensor system 105.

The at least one processor (e.g., 122, at least one processor of the optical sensor system 105, and/or the at least one processor of the at least one computing device 124) may be configured to (e.g., collectively configured to and/or configured in series and/or parallel to, if more than one processor): perform any or all of the operations disclosed throughout.

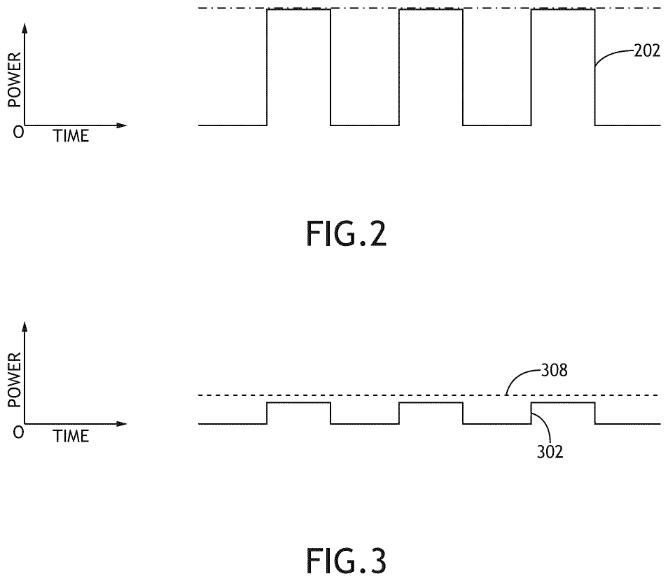

Referring now to FIG. 2, an exemplary graph, with respect to an exemplary laser signal (e.g. a pulsed laser signal) emitted by the laser emitter 106, of laser power versus time for the exemplary laser signal is shown according to the inventive concepts disclosed herein. The graph of FIG. 2 depicts an exemplary square wave signal 202. For FIG. 2, the dotted line exemplarily represents a maximum baseline situation for laser transmission through a clean window. FIG. 2 is associated with a situation where the second surface 102B (e.g., exterior surface) of the window 102 lacks contaminants that would attenuate the laser 108 transmitted through the second surface 102B.

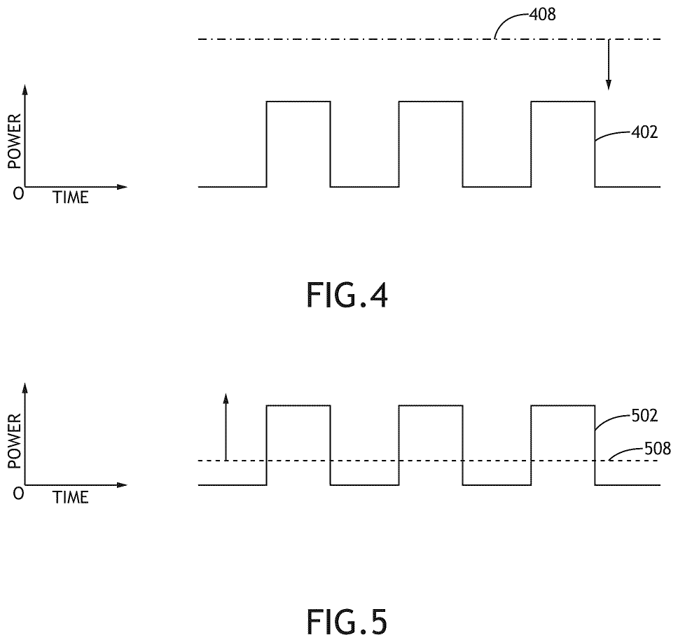

Referring now to FIG. 3, an exemplary graph, with respect to an exemplary electric signal (associated with backscatter rays 110 from the laser signal illustrated by and described with respect to FIG. 2) (e.g., a digital electric signal corresponding) output by the ADC 120, of electric signal power versus time for the exemplary electric signal is shown according to the inventive concepts disclosed herein. The graph of FIG. 3 depicts an exemplary electric signal curve 302 and an exemplary electric signal threshold 308 that the clean window backscatter signal has not yet exceeded. As the pulse height of the backscattered laser signal increases above the threshold, the pulse height of the transmitted laser signal decreases below the baseline signal. FIG. 3 is associated with a situation where the second surface 102B (e.g., exterior surface) of the window 102 lacks contaminants that would attenuate the laser 108 transmitted through the second surface 102B.

Referring to FIGS. 2-3, most or all of the laser 108 is transmitted through the window 102, the photodetector 117 has little to no output, and the processor 122 determines that no thresholds are tripped by the processor 122.

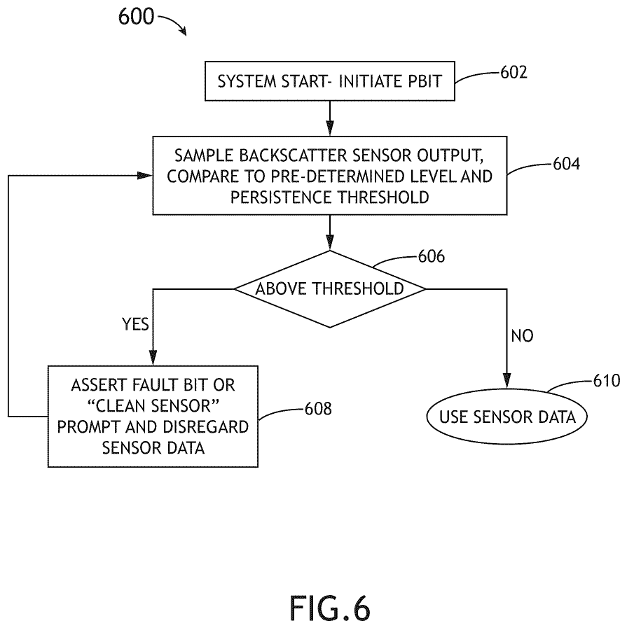

Referring now to FIG. 4, an exemplary graph, with respect to an exemplary laser signal emitted by the laser emitter 106, of laser power versus time for the exemplary laser signal is shown according to the inventive concepts disclosed herein. The graph of FIG. 4 depicts an exemplary laser power curve 402 and an exemplary laser threshold 408. FIG. 4 is associated with a situation where the second surface 102B (e.g., exterior surface) of the window 102 has contaminants that would attenuate the laser 108 transmitted through the second surface 102B.

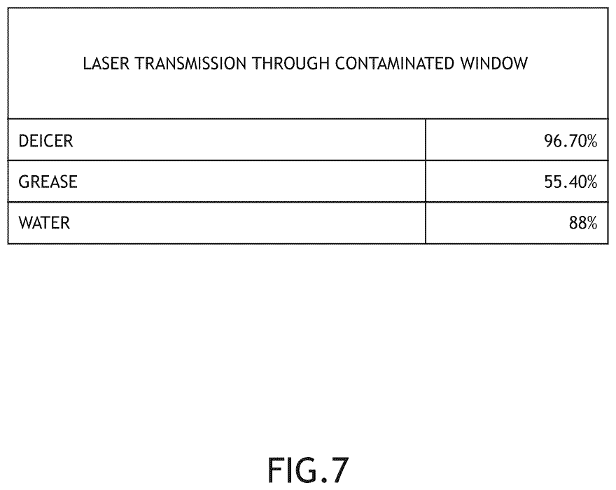

Referring now to FIG. 5, an exemplary graph, with respect to an exemplary electric signal (associated with backscatter rays 110 from the laser signal illustrated by and described with respect to FIG. 4 (e.g., a digital electric signal corresponding) output by the ADC 120, of electric signal power versus time for the exemplary electric signal is shown according to the inventive concepts disclosed herein. The graph of FIG. 5 depicts an exemplary electric signal curve 502, and an exemplary electric signal threshold 508. FIG. 5 is associated with a situation where the second surface 102B (e.g., exterior surface) of the window 102 has contaminants that would attenuate the laser 108 transmitted through the second surface 102B.

Referring to FIGS. 4-5, contaminants on the second surface 102B of the window 102 scatter a significant amount (e.g., most or all) of the laser 108 transmitted through the window 102, the photodetector 117 increases its voltage output in response the higher amount of detected backscatter rays 110, the processor 122 determines that thresholds are, and the processor 122 outputs an alarm, instruction, or signal in response such determination.

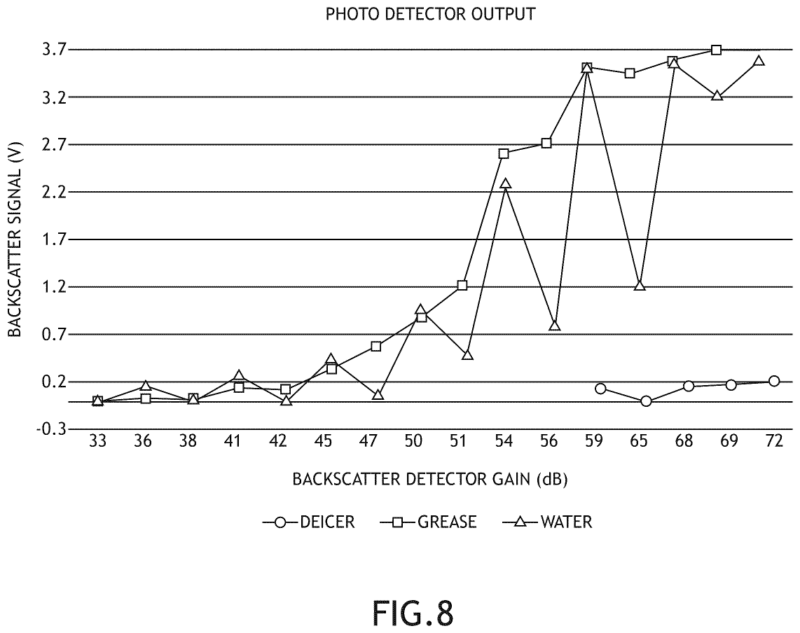

Referring now to FIG. 6, an exemplary embodiment of a method 600 according to the inventive concepts disclosed herein may include one or more of the following steps. Additionally, for example, some embodiments may include performing one or more instances of the method 600 iteratively, concurrently, and/or sequentially. Additionally, for example, at least some of the steps of the method 600 may be performed in parallel and/or concurrently. Additionally, in some embodiments, at least some of the steps of the method 600 may be performed non-sequentially.

A step 602 may include by the at least one processor 122 and/or the computing device 124: initiating a pre-flight built-in test (PBIT) or in-flight BIT.

A step 604 may include by the at least one processor 122 and/or the computing device 124: sampling at least one power level and/or at least one persistence level of at least one electric signal (e.g., at least one analog electric signal output by the at least one photodetector 117, the at least one amplified electric signal output by the at least one amplifier 118, and/or the at least one digital electric signal output by the at least one ADC 120); and comparing the at least one sampled power level and/or the at least one sampled persistence level of the at least one electric signal against at least one predetermined threshold power level and/or at least one predetermined persistence threshold.

A step 606 may include by the at least one processor 122 and/or the computing device 124: determining whether the at least one sampled power level and/or the at least one sampled persistence level of the at least one electric signal exceeds the at least one predetermined threshold power level and/or the at least one predetermined persistence threshold.

A step 608 may include by the at least one processor 122 and/or the computing device 124: upon a determination that the at least one sampled power level and/or the at least one sampled persistence level of the at least one electric signal trip(s) (e.g., exceeds) the at least one predetermined threshold power level and/or the at least one predetermined persistence threshold, asserting a fault bit, outputting an instruction, message, and/or alert to initiate a prompt to clean the window, and/or disregarding data collected by the optical sensor system 105.

A step 610 may include by the at least one processor 122 and/or the computing device 124: upon a determination that the at least one sampled power level and/or the at least one sampled persistence level of the at least one electric signal passes (e.g., fails to exceed) the at least one predetermined threshold power level and/or the at least one predetermined persistence threshold, continue to use and/or allow the use of the data collected by the optical sensor system 105. Persistence refers to the amount of time the backscattered power signal is above the threshold. For example, a failure would be noted when the power signal is above the threshold for a certain amount of time; this can preclude flagging transient events that would be unlikely to degrade sensor system performance.

Further, the method 600 may include any of the operations disclosed throughout.

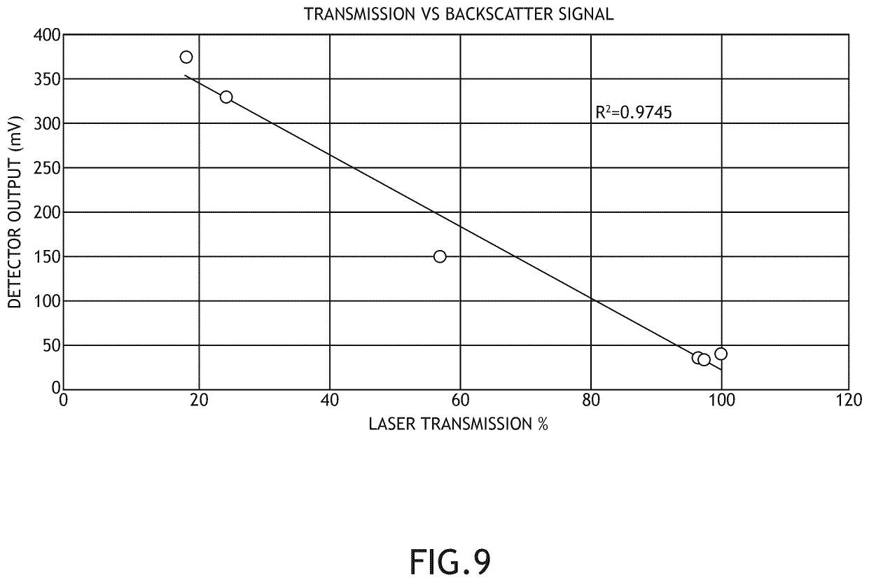

FIGS. 7, 8, and 9 illustrate a portion of test result data associated with one exemplary and tested embodiment. Deicer, grease, and water are three of the most common contaminants that can impair Lidar systems that transmit laser signals through aircraft windows. One of deicer, grease, and water were placed on the window in separate trials to evaluate how the backscattered signal varies with increased gain levels.

Referring now to FIG. 7, an exemplary table, which illustrates a portion of test result data with respect to the one exemplary and tested embodiment is shown according to the inventive concepts disclosed herein. For example, percentages of laser transmission through the tested contaminated window are shown in the table of FIG. 6.

Referring now to FIG. 8, an exemplary graph, which illustrates a portion of test result data with respect to the one exemplary and tested embodiment is shown according to the inventive concepts disclosed herein. For example, the graph of FIG. 8 illustrates a voltage of the photodetector's output (in volts (V)) plotted against a backscatter signal detector gain (in dB) for the photodetector 117 output in response to the detection of backscatter rays 110 for each of the deicer, grease, and water test scenarios. Deicer was accurately (e.g., correctly) not detected by the photodetector 117; deicer is a common contaminant that typically does not affect laser transmission through a window, and the test data confirmed that the exemplary embodiment accurately did not have a backscatter signal and did not trigger a contamination warning. Grease was accurately detected by the photodetector 117. Water detection appeared to be dependent on droplet location, which could be addressed by setting a persistence threshold to a suitably-long time interval (e.g., which may be predetermined via adequate further testing) of high backscatter signal.

Referring now to FIG. 9, an exemplary graph, which illustrates a portion of test result data with respect to the one exemplary and tested embodiment is shown according to the inventive concepts disclosed herein.

Referring still to FIGS. 7-9, the preliminary test results indicated a relationship between transmission power and backscattered light from liquid contaminants to be inversely proportional. The results indicate that the photodetector 117 not only senses the contaminants but is also a direct indicator of signal transmission strength.

Based on the preliminary test results, there appears to be minimal risk of false positive outputs by the photodetector 117. During lab testing, materials that did not significantly disrupt the transmission of the laser also produced little to no output from the photodetector 117. Contaminants that are unlikely to disrupt the optical sensor system performance (e.g., attenuate the laser 108) performance were not flagged by this method. There appears to be a strong correlation between probability of detection and severity of contamination. Lab tests showed an apparent inverse relationship between the transmission percentage of the laser and the backscatter signal measurements for most contaminants. Contaminants that are the most likely to disrupt the optical sensor system 105 performance were the most easily detected by the photodetector 117.

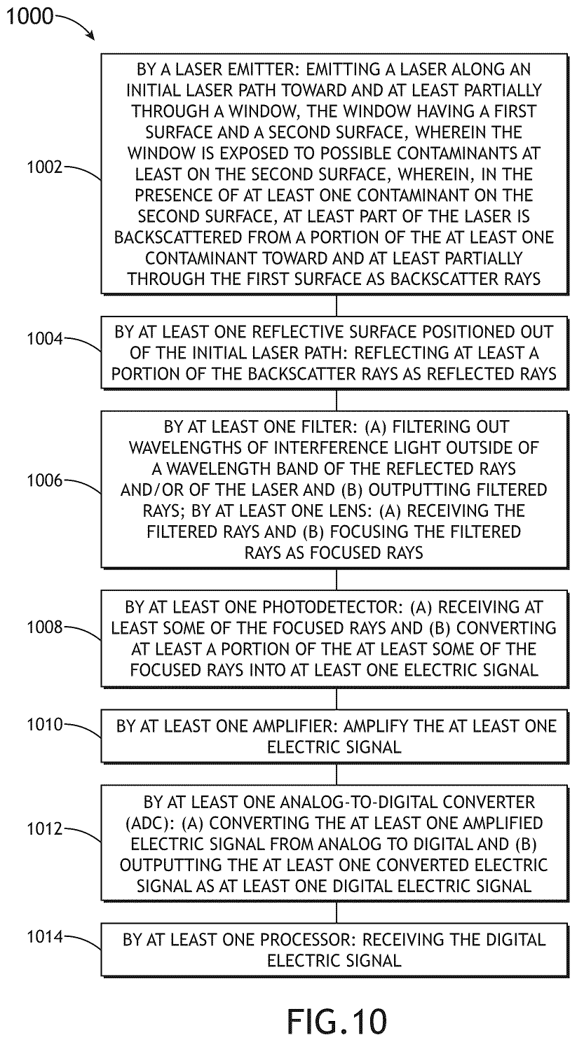

Referring now to FIG. 10, an exemplary embodiment of a method 1000 according to the inventive concepts disclosed herein may include one or more of the following steps. Additionally, for example, some embodiments may include performing one or more instances of the method 1000 iteratively, concurrently, and/or sequentially. Additionally, for example, at least some of the steps of the method 1000 may be performed in parallel and/or concurrently. Additionally, in some embodiments, at least some of the steps of the method 1000 may be performed non-sequentially.

A step 1002 may include by a laser emitter: emitting a laser along an initial laser path toward and at least partially through a window, the window having a first surface and a second surface, wherein the window is exposed to possible contaminants at least on the second surface, wherein, in the presence of at least one contaminant on the second surface, at least part of the laser is backscattered from a portion of the at least one contaminant toward and at least partially through the first surface as backscatter rays.

A step 1004 may include by at least one reflective surface positioned out of the initial laser path: reflecting at least a portion of the backscatter rays as reflected rays.

A step 1006 may include by at least one filter: (a) filtering out wavelengths of interference light outside of a wavelength band of the reflected rays and/or of the laser and (b) outputting filtered rays.

A step 1008 may include by at least one lens: (a) receiving the filtered rays and (b) focusing the filtered rays as focused rays.

A step 1010 may include by at least one photodetector: (a) receiving at least some of the focused rays and (b) converting at least a portion of the at least some the focused rays into at least one electric signal.

A step 1012 may include by at least one amplifier: amplify the at least one electric signal.

A step 1014 may include by at least one analog-to-digital converter (ADC): (a) converting the at least one amplified electric signal from analog to digital and (b) outputting the at least one converted electric signal as at least one digital electric signal.

A step 1016 may include by at least one processor: receiving the digital electric signal.

Further, the method 1000 may include any of the operations disclosed throughout.

As will be appreciated from the above, embodiments of the inventive concepts disclosed herein may be directed to a system (e.g., an optical sensor system, such as a Lidar sensor system), a vehicular system (e.g., an aircraft system), and/or a system including a laser emitter (e.g., of an optical sensor system or another laser emitter), a window, at least one photodetector, and/or at least one processor) and a method configured to determine an occurrence of contamination on at least one surface of a window.

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system, comprising:
a laser emitter configured to emit a laser along an initial laser path toward and at least partially through a window, the window having a first surface and a second surface, wherein the window is exposed to possible contaminants at least on the second surface, wherein, in a presence of at least one contaminant on the second surface, at least part of the laser is backscattered from a portion of the at least one contaminant toward and at least partially through the first surface as backscatter rays;
at least one reflective surface positioned out of the initial laser path, the at least one reflective surface configured to reflect at least a portion of the backscatter rays as reflected rays;
at least one filter configured to filter out wavelengths of interference light outside of a wavelength band of the reflected rays and/or of the laser and to output filtered rays;
at least one lens configured to receive the filtered rays and to focus the filtered rays as focused rays;
at least one photodetector configured to receive at least some of the focused rays and to convert at least a portion of the at least some the focused rays into at least one electric signal;
at least one amplifier configured to amplify the at least one electric signal;
at least one analog-to-digital converter (ADC) configured to convert the at least one amplified electric signal from analog to digital and to output the at least one converted electric signal as at least one digital electric signal; and
at least one processor configured to receive the digital electric signal.

2. The system of claim 1, wherein the initial laser path is orthogonal to at least one of the first surface or the second surface.

3. The system of claim 1, wherein the laser emitter, the at least one reflective surface, the at least one filter, the at least one lens, the at least one photodetector, the at least one ADC, and the at least one processor are installed in a vehicle.

4. The system of claim 3, wherein the vehicle is an aircraft.

5. The system of claim 3, wherein the window is a vehicular window.

6. The system of claim 1, wherein the window is an optical sensor system window.

7. The system of claim 1, wherein the at least one reflective surface is of at least one mirror.

8. The system of claim 1, wherein the at least one filter comprises at least one band-pass filter (BPF).

9. The system of claim 1, wherein the at least one filter comprises at least one low-pass filter (LPF) and at least one high-pass filter (HPF) arranged in series so as to collectively operate as at least one band-pass filter (BPF).

10. The system of claim 1, wherein the at least one photodetector comprises at least one photodiode.

11. The system of claim 1, wherein the at least one processor is further configured to: output at least one instruction and/or at least one output signal based at least on at least one comparison of one or more of the at least one digital electric signal to a predetermined threshold level, wherein each of the at least one digital electric signal is associated with a power of an analog signal of one of the at least one electric signal or one of the at least one amplified electric signal.

12. The system of claim 1, wherein the at least one processor is further configured to: output at least one instruction, at least one message, at least one alert and/or at least one output signal based at least on a determination that at least one sampled power level and/or at least one sampled persistence level associated with the at least one digital electric signal exceeds at least one predetermined threshold power level and/or at least one predetermined persistence threshold.

13. The system of claim 1, wherein the at least one processor is further configured to: obtain laser power information associated with at least one power of the laser; and determine and/or obtain digital electric signal information associated with at least one of (a) at least one power or (b) at least one of at least one current or at least one voltage of at least one analog signal of the at least one electric signal and/or of the at least one amplified electric signal.

14. The system of claim 13, wherein the at least one processor is further configured to: compare the laser power information and the digital electric signal information; and based at least on the comparison of the laser power information and the digital electric signal power information, determine that at least one of the first or second surface is contaminated and/or is likely contaminated.

15. The system of claim 14, wherein the at least one processor is further configured to: determine at least one type of matter that is contaminating the first and/or second surface.

16. The system of claim 15, wherein the at least one determined type of the matter is at least one of liquid water, ice, or grease.

17. The system of claim 14, wherein the at least one processor is further configured to: cause an alert to be issued, wherein the alert is indicative that the at least one of the first or second surface is contaminated and/or is likely contaminated.

18. The system of claim 14, wherein the at least one processor is further configured to: cause a maintenance event to be scheduled to clean the at least one of the first or second surface.

19. The system of claim 14, wherein the system is an optical sensor system, wherein the at least one processor is further configured to: cause at least one of (a) a deactivation of the laser emitter and/or the optical sensor system or (b) an alert to be issued, wherein the alert is indicative that information obtained by the optical sensor system is at least one of unreliable.

20. A method, comprising:
by a laser emitter: emitting a laser along an initial laser path toward and at least partially through a window, the window having a first surface and a second surface, wherein the window is exposed to possible contaminants at least on the second surface, wherein, in a presence of at least one contaminant on the second surface, at least part of the laser is backscattered from a portion of the at least one contaminant toward and at least partially through the first surface as backscatter rays;
by at least one reflective surface positioned out of the initial laser path: reflecting at least a portion of the backscatter rays as reflected rays;
by at least one filter: (a) filtering out wavelengths of interference light outside of a wavelength band of the reflected rays and/or of the laser and (b) outputting filtered rays;
by at least one lens: (a) receiving the filtered rays and (b) focusing the filtered rays as focused rays;
by at least one photodetector: (a) receiving at least some of the focused rays and (b) converting at least a portion of the at least some of the focused rays into at least one electric signal;
by at least one amplifier: amplify the at least one electric signal;
by at least one analog-to-digital converter (ADC): (a) converting the at least one amplified electric signal from analog to digital and (b) outputting the at least one converted electric signal as at least one digital electric signal; and
by at least one processor: receiving the digital electric signal.
